(19) United States
(12) Patent Application Publication
(10) Pub. No.: US 2008/0262909 A1
(43) Pub. Date: Oct. 23, 2008

(54) INTELLIGENT INFORMATION DISPLAY

(75) Inventors: Li Li, Issaquah, WA (US); Robert A. Sim, Vancouver (CA); Tarek Najm, Redmond, WA (US); Ying Li, Bellevue, WA (US); Yi Chen, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/736,831

(22) Filed: Apr. 18, 2007

(51) Int. Cl. G06Q 30/00

(52) U.S. Cl. 705/14; 702/1

(57) ABSTRACT

Computer-readable media, systems, and methods for intelligent information display are described. In embodiments, a display environment is monitored for one or more audience data and, upon receiving the one or more audience data, display information is processed in accordance with the one or more audience data and the processed display information is presented. In various embodiments, the audience data includes user gestures that indicate a communication with the intelligent information display, such as gestures indicating a mouse motion or a mouse click. In various other embodiments, the audience data includes demographic indicia such as the typical gender and/or typical age of an audience in a display environment.

### BACKGROUND

Advertisers exhaust massive amounts of financial resources every year in an attempt to reach consumers of all types. Traditional forms of advertising, though still effective, are beginning to give way to more modern approaches suited for life in the Information Age. For instance, web banners and online video advertisements are increasingly common and their viability and effectiveness certainly parallels the expansion of Internet usage nationally.

Unfortunately, with all the advertising advances in the last decade, advertisers are still unable to specifically target advertisements directly to consumers because, in many environments, the type and number of consumers exposed to any advertisement is largely unknown. Many advertisements are relatively static and incapable of adapting to various audiences. For example, a sign in an airport may be rotated on a monthly basis, but the rotation schedule is likely dictated by pre-set fee arrangements and contract negotiations, rather than consumer demand. Further, traditional billboards and signs do not allow for interaction with the consumers and are unable to engage a consumer for an extended period of time. Finally, although some advertisers can rely upon television ratings and Internet “hits” to determine how many times their advertisements have been viewed, there is no way to tell how many people walk past an advertisement in a shopping mall and no effective way to determine the number and type of vehicles passing a billboard on a highway. Advertisers miss an incredibly lucrative advertising opportunity because of the unavailability of dynamic displays that monitor an environment and adjust for an audience of consumers.

### SUMMARY

Embodiments of the present invention relate to computer-readable media, systems, and methods for intelligent information display. In embodiments, a display environment is monitored for one or more audience data and, upon receiving one or more audience data, processing display information in accordance with the one or more audience data and displaying the processed information. In embodiments, the audience data includes user gestures that indicate a user's desire to interact with the intelligent information display, such as gestures indicating a mouse motion or mouse click. Further, in embodiments, the audience data includes demographic indicia such as gender and age information of an audience in a display environment.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing system environment suitable for use in implementing the present invention;

FIG. 2 is a block diagram illustrating an exemplary system for intelligent information display, in accordance with an embodiment of the present invention;

FIG. 3 is a flow diagram illustrating an exemplary method for intelligent information display utilizing user gestures, in accordance with an embodiment of the present invention;

FIG. 4 is a flow diagram illustrating an exemplary method for intelligent information display utilizing audience measurement indicia, in accordance with an embodiment of the present invention; and

FIG. 5 is a flow diagram illustrating an exemplary method for intelligent information display utilizing traffic data, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computer-readable media, systems, and methods for intelligent information display. In various embodiments, a display environment is monitored for one or more audience data and, upon receiving one or more audience data, processing display information in accordance with the one or more audience data. Further, in various embodiments, the processed display information is displayed. While embodiments discussed herein refer to communications between system components on a private network, it will be understood by one of ordinary skill in the art that embodiments are not limited to a private network or any particular network type. For example, other embodiments may communicate between components via the Internet.

Accordingly, in one aspect, the present invention is directed to a computer-implemented method for intelligent information display. The method includes monitoring a display environment for one or more audience data. The method further includes, upon receiving the one or more audience data, processing display information in accordance with the one or more audience data. Further, the method includes presenting the processed display information.

In another aspect, the present invention is directed to a computerized system for intelligent information display. The system includes a monitoring component configured to monitor a display environment and to receive data from activity in the display environment, a gesture recognition component configured to recognize user gestures in the display environment, and an audience measurement component configured to determine audience demographic information of the display environment. The system further includes a database for storing received information from the display information.

In yet another embodiment, the present invention is directed to one or more computer readable media having instructions embodied thereon that, when executed, perform a method for intelligent information display. The method includes monitoring a display environment for one or more traffic data. The method further includes, upon receiving the one or more traffic data, processing display information in accordance with the one or more traffic data. Further, the method includes presenting the processed display information.

Having briefly described an overview of embodiments of the present invention, an exemplary operating environment is described below.

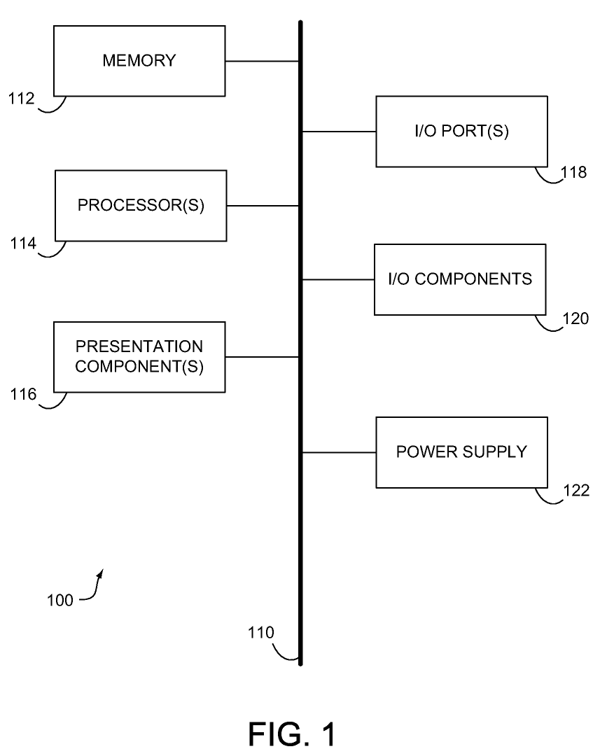

Referring to the drawing figures in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the present invention may be described in the general context of computer code or machine-usable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, handheld devices, consumer electronics, general purpose computers, specialty computing devices, and the like. Embodiments of the invention may also be practiced in distributed computing environments where tasks are performed by remote processing devices that are linked through a communications network. In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

Computing device 100 includes a bus 110 that directly or indirectly couples the following elements: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid state memory, hard drives, optical disc drives, and the like. Computing device 100 includes one or more processors that read from various entities such as memory 112 or I/O components 120. Presentation component(s) 116 present data indications to a user or other device. Exemplary presentation components include a display device, speaker, printing component, vibrating component, and the like.

I/O ports 118 allow computing device 100 to be logically coupled to other devices including I/O components 120, some of which may be built in. Illustrative components include a microphone, joystick, game pad, satellite dish, scanner, printer, wireless device, etc.

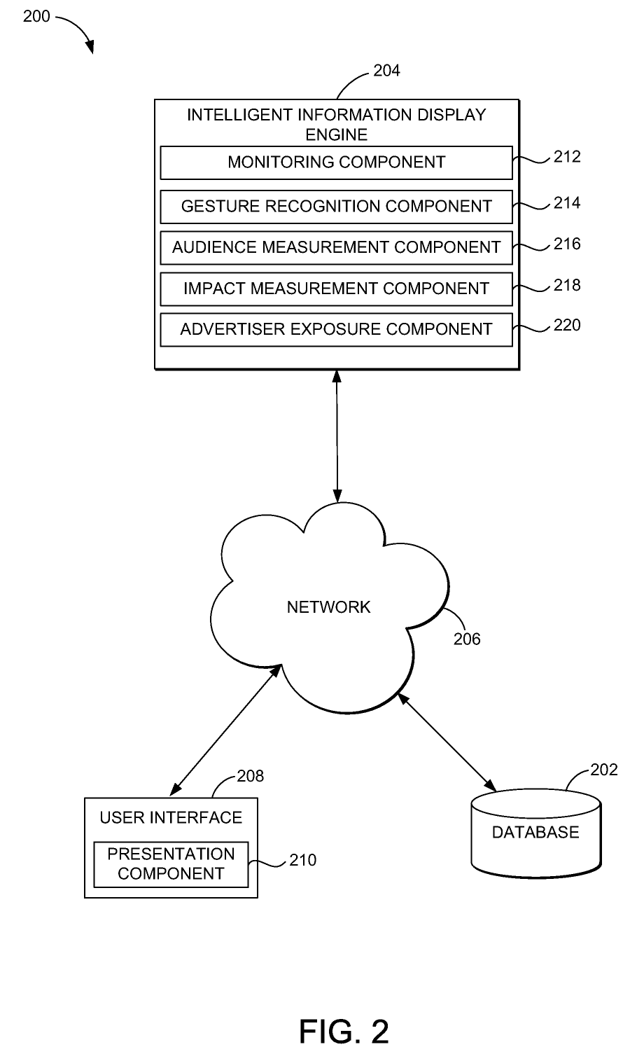

Turning now to FIG. 2, a block diagram is provided illustrating an exemplary system 200 for intelligent information display, in accordance with an embodiment of the present invention. The system 200 includes a database 202, an intelligent information display engine 204, and a user interface 208 in communication with one another via a network 206. Network 206 may include, without limitation, one or more local area networks (LANs) and/or wide area networks (WANs). Such networking environments are commonplace in offices, enterprise-wide computer networks, intranets, and the Internet. Accordingly, network 206 is not further described herein.

Database 202 is configured to store information associated with the intelligent information display environment. In various embodiments, such information may include, without limitation, audience size, audience age, audience gender, traffic speed, traffic congestion, traffic composition, and any combination thereof. Further, database 202 is configured to store information associated with display content for the intelligent information display. In various embodiments, such information may include, without limitation, advertisements, public service announcements, weather information, and any other type of information capable of electronic display. In various embodiments, database 202 is configured to be searchable so that the intelligent information display can search for and display content based on the present status of the display environment. It will be understood and appreciated by those of ordinary skill in the art that the information stored in database 202 may be configurable and may include various information relevant to an intelligent information display. The content and/or volume of such information are not intended to limit the scope of embodiments of the present invention in any way. Further, though illustrated as a single, independent component, database 202 may, in fact, be a plurality of databases, for instance, a database cluster, portions of which may reside on a computing device associated with intelligent information display engine 204, associated with user interface 208, on another external computing device (not shown), or any combination thereof.

User interface 208 may be a type of computing device, such as computing device 100 described with reference to FIG. 1, for example, and includes at least one presentation component 210. Presentation component 210 is configured to present (e.g. display) display information based upon user gestures and audience demographic information received from activity in a display environment. For example, without limitation, the display information may be an advertisement specifically targeted to a particular audience.

Intelligent information display engine 204 may be a type of computing device, such as computing device 100 described with reference to FIG. 1, and includes a monitoring component 212, a gesture recognition component 214, an audience measurement component 216, an impact measurement component 218, and an advertiser exposure component 220. Further intelligent information display engine 204 is configured to operate utilizing at least a portion of the information stored in database 202.

Monitoring component 212 is configured to monitor a display environment and to receive data from an activity in the display environment. In various embodiments, by way of example, monitoring component 212 may be a single camera. For instance, without limitation, the camera is configured to operate in various operating environments without the need for specially controlled illumination or special targets. In these embodiments, the single camera, operating in a display environment with typical lighting, can select and focus on a target portion of the audience using a region of attention applied to various activities. Thus, in these various embodiments, the camera is not distracted by constant motion within the display environment because monitoring component 212 has the capability of ignoring certain environmental conditions. Further, in these various embodiments, perfect lighting is unnecessary because monitoring component 212 is configured to adapt to various lighting schemes and still receive data from an activity in the display environment.

In various embodiments, monitoring component 212 may receive data about an audience in the display environment. In various embodiments, the data may involve the size of the audience at a particular time, the total number of people present in an audience over the course of a longer period of time, or data about a single member of the audience. For example, without limitation, monitoring component 212 may be in an airport and may track the number of people walking by on an average day. As another example, without limitation, monitoring component 212 may be in a train station and may receive information about the number of passengers or other people currently present. In these various embodiments, the received information will allow intelligent information display engine 204 to target displays via presentation component 210 based upon the audience data.

In various other embodiments, monitoring component 212 may further receive data about traffic in the display environment. In various embodiments, by way of example, the traffic data may involve traffic speed, traffic congestion and/or traffic composition. For example, without limitation, monitoring component 212 may be located on a busy interstate highway and may receive information about the speed of vehicles presently passing by. As another example, without limitation, monitoring component 212 may receive information about the type of vehicles presently passing by or monitoring component 212 may track the total number of vehicles passing on a given day. Again, in these various embodiments, the received information will allow intelligent information display engine 204 to target displays via presentation component 210 based upon traffic data. The nature and extent of information received by monitoring component 212 may be stored, e.g., in database 202.

Gesture recognition component 214 is configured to recognize user gestures in the display environment. In various embodiments, by way of example, gesture recognition component 214 is capable of interpreting movements of a member of a display environment audience and using the movement interpretations to allow the audience member to interact with intelligent information display engine 204. For example, without limitation, gesture recognition component 214 may measure what one of ordinary skill in the art would understand as a mouse motion. The mouse motion would function similar to any type of pointer movement typically associated with a computing device, such as computing device 100 described with reference to FIG. 1. In various embodiments, without limitation, to determine a mouse motion, gesture recognition component 214 maps a region of largest motion in a display environment and applies a region of attention to a location in the display environment containing the motion. In this embodiment, the region of attention ensures that gesture recognition component 214 is not distracted by the other motions in the display environment. In various embodiments, a member of the audience, or user, would interact with gesture recognition component 214 by approaching and pointing toward user interface 208. Information presented on presentation component 210 will be adjusted according to the gestures of the user identified by gesture recognition component 214.

In various other embodiments, gesture recognition component 214 is capable of interpreting what one of ordinary skill in the art would understand as mouse click. The mouse click would function similar to any type of click typically associated with a computing device, such as computing device 100 described with reference to FIG. 1. In various embodiments, without limitation to determine a mouse click, gesture recognition component 214 considers a sequence of recent user motions in the region of attention. By way of example, the user may indicate a mouse click by wiggling a finger. In this example, gesture recognition component 214 considers the recent user motions such as the average flow magnitude and distance traveled in the image. If the flow magnitude is large but the distance traveled is small, gesture recognition component 214 interprets a mouse click. Again intelligent information display engine 204 uses the gesture information from gesture recognition component 214 and information presented on presentation component 210 will be adjusted accordingly. For example, using mouse motion and mouse click gestures, a user can interact with intelligent information display engine 204. In various embodiments, the interaction may allow the user to select a type of advertisement to display, such as a short video or various pictures. Additionally, in other embodiments, the interaction may take place in a video game setting, allowing the user to interact with the game without touching the screen or an attached device. In yet other embodiments, the gaming feature and advertisement feature may be combined, allowing the user to play a short game wherein the purpose of the game is both to engage the user and to present the user with advertising information.

Audience measurement component 216 is configured to determine an audience demographic information of the display environment. In various embodiments, by way of example, audience measurement component 216 is capable of detecting faces in the audience. In various embodiments using information from the face detection, audience measurement component 216 is capable of determining demographic information. By way of example, without limitation, audience measurement component 216 can measure the gender of members of the audience based on face detection information. As a further example, without limitation, the audience measurement component can measure the age of members of the audience.

Intelligent information display engine 204 uses the demographic information from audience measurement component 216 and information presented on presentation component 210 will be adjusted accordingly. For example, without limitation, if audience measurement component 216 interprets a predominately female audience, intelligent information display engine 204 may present, via presentation component 210, advertisements particularly attractive to a female audience. In another example, if audience measurement component 216 interprets a young audience, intelligent information display engine 204 may present, via presentation component 210, advertisements targeted to young people.

Impact measurement component 218 is configured to measure a typical size of the audience in the display environment and to determine an amount of time individual audience members remain in the display environment. In various embodiments, the impact measurement component is capable of collecting audience information and storing that information in database 202. The information may be of use to advertisers or other users of the intelligent information display. By way of example, without limitation, advertisers would be very interested to know how large their audience is as well as how engaged the audience is with particular advertisements. In various embodiments, impact measurement component 218 can collect this information for advertisers. In this example, using measurements of audience size as well as the time of audience engagement allows advertisers to determine which advertisements are most effective as well as where advertisements receive the most attention, information invaluable to any advertiser.

Advertiser exposure component 220 is configured to transmit the audience demographic information and an impact measurement information to advertisers and potential advertisers. In various embodiments, without limitation, advertiser exposure component 220, actually communicates the information collected by impact measurement component 218 to advertisers. Additionally, in various other embodiments, advertiser exposure component 220 communicates demographic information to advertisers. By way of example, advertisers might be interested to know the typical age and gender composition of an advertising location so that the advertisers can best attract the interest of the audience. Thus, in various embodiments, advertiser exposure component 220 will send this demographic information, collected by audience measurement component 216, to the advertisers. In yet other embodiments, the advertiser exposure component will send demographic and impact information to potential advertisers so that the potential advertisers can make an informed decision about where and when to place their advertisements as well as which advertisements might be most effective.

It will be understood and appreciated by those of ordinary skill in the art that additional components not shown may also be included within any of system 200, database 202, intelligent information display engine 204, and user interface 208.

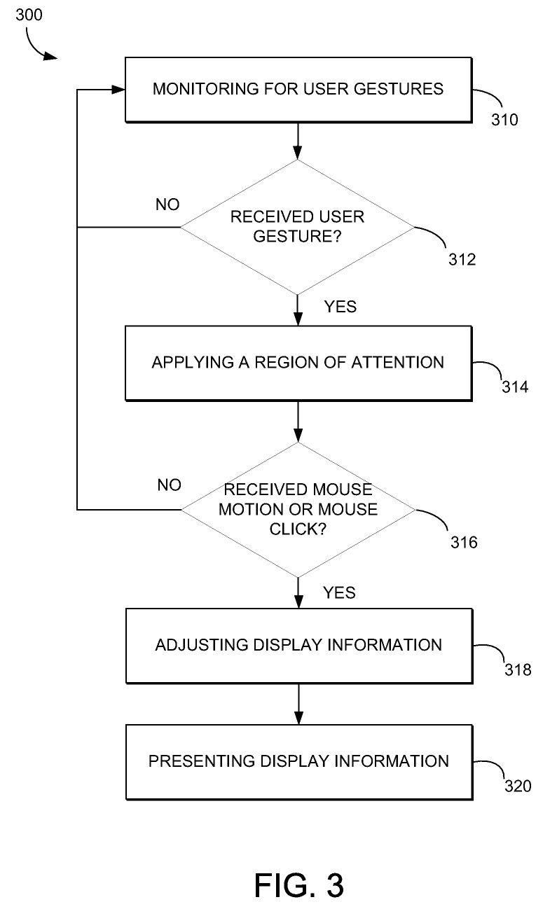

Turning now to FIG. 3, a flow diagram of an exemplary method for intelligent information display utilizing user gestures, in accordance with an embodiment of the present invention, is illustrated and designated generally as reference numeral 300. Initially, as indicated at block 310, user gestures are monitored for, e.g., by monitoring component 212 of FIG. 2. By way of example, the user gesture may be a user approaching and pointing at user interface 208 of FIG. 2. In various embodiments, a user gesture is any movement by a user that might be interpreted as a mouse motion or a mouse click. In other embodiments, a user gesture is any motion by a user at all, so that every user gesture may be monitored. Any and all such variations, and any combinations thereof, are contemplated to be within the scope of embodiments of the present invention.

Next, as indicated at block 312, it is determined if a user gesture is received. If it is determined that a user gesture is not received, the method returns to block 310 and continues monitoring for user gestures. If, however, it is determined that a user gesture is received, a region of attention is applied (e.g. utilizing monitoring component 212 of FIG. 2) to the area in which the user gesture originated, as indicated at block 314. As previously discussed, the region of attention allows the intelligent information display to distinguish user gestures from other, unimportant motions taking place in the display environment. In various embodiments, the region of attention may be large, accommodating a number of users in the audience. In various other embodiments, the region of attention may be smaller, focusing on only one user or only a part of one user.

Next, as indicated at block 316, it is determined if a mouse motion or mouse click is received. If it is determined that a mouse click is not received, the method returns to block 310 and continues monitoring for user gestures. If, however, it is determined that a mouse motion or mouse click is received, the display information is adjusted according to the received mouse motion or mouse click, as indicated at block 318. For example, without limitation, upon receiving a mouse motion, the display information might be adjusted to show a pointer moving on the screen. As another example, without limitation, upon receiving a mouse click, the display information might be adjusted depending on where the mouse click took place, such as where on user interface 208 of FIG. 2.

Next, as indicated at block 320, display information may be presented, e.g. by presentation component 210 of FIG. 2. As previously described, various display information can be presented in a number of formats in order to most appropriately adjust to the display environment. For example, without limitation, a short video clip selected by the user with gestures of mouse motions and mouse clicks may be presented.

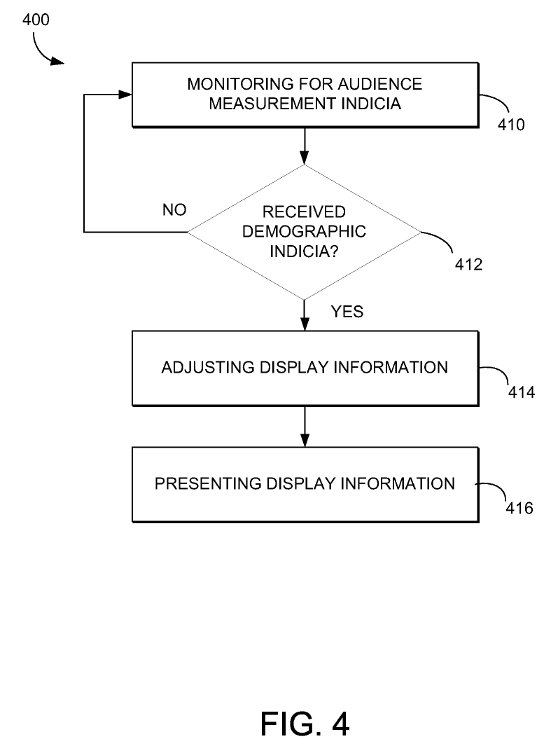

Turning now to FIG. 4, a flow diagram of an exemplary method for intelligent information display utilizing audience measurement indicia, in accordance with an embodiment of the present invention, is illustrated and designated generally as reference numeral 400. Initially, as indicated at block 410, audience measurement indicia are monitored for, e.g., by monitoring component 212 of FIG. 2. By way of example, without limitation, the audience measurement indicia may be demographic information about the gender and age of the audience. As a further example, the audience measurement indicia may be an assessment of the number of members of the audience at a specific time or a count of the number of audience members over the course of a longer period of time, such as a day or a week. Any and all such variations, and any combinations thereof, are contemplated to be within the scope of embodiments of the present invention.

Next, as indicated at block 412, it is determined if a demographic indicia is received. If it is determined that a demographic indicia is not received, the method returns to block 410 and continues monitoring for audience measurement indicia. If, however, it is determined that a demographic indicia is received, the display information is adjusted according to the received demographic indicia, as indicated at block 414. As previously stated, the display information might be adjusted to present an advertisement that is specially tailored to the gender and/or age demographic present in the display environment.

Next, as indicated at block 416, display information is presented, e.g., by presentation component 210 of FIG. 2. As previously described, various display information can be presented in a number of formats in order to most appropriately adjust to the display environment. For example, without limitation, a make-up advertisement may be presented where there is a largely female demographic.

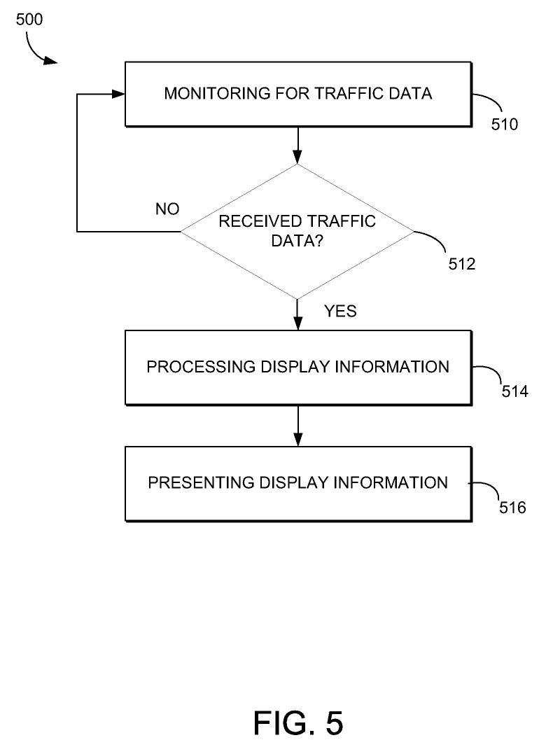

Turning now to FIG. 5, a flow diagram of an exemplary method for intelligent information display utilizing traffic data, in accordance with an embodiment of the present invention, is illustrated and designated generally as reference numeral 500. Initially, as indicated at block 510, traffic data is monitored for, e.g., by monitoring component 212 of FIG. 2. By way of example, without limitation, the traffic data may include traffic congestion, traffic speed, and/or the vehicles in the traffic. Any and all such variations, and any combinations thereof, are contemplated to be within the scope of embodiments of the present invention.

Next, as indicated at block 512, it is determined if traffic data is received. If it is determined that traffic data is not received, the method returns to block 510 and continues monitoring for traffic data. If, however, it is determined that traffic data is received, the display information is processed according to the received traffic data, as indicated at block 514. By way of example, without limitation, if the traffic is moving very slowly, the display information might be adjusted so that short videos will be displayed by the intelligent information display, or, advertisements might be shown changing at a quicker rate so that each vehicle is exposed to more advertisements. As another example, without limitation, if traffic is moving very quickly, the intelligent information display might only display advertisements, rather than videos, and the advertisements might change at a slower rate so that each vehicle is exposed to an advertisement for a sufficient amount of time. In yet another example, without limitation, the composition of the traffic may be used to target advertisements. In this example, if there are mostly semi-trucks on the highway, the intelligent information display might display advertisements that would be of interest to a typical driver of a semi-truck.

Next, as indicated at block 516, display information is presented, e.g., by presentation component 210 of FIG. 2. As previously described, various display information can be presented in a number of formats in order to most appropriately adjust to the display environment. Further, by way of example, without limitation, the display information might include public service announcements. In this example, announcements, such as Amber Alerts, could be displayed using the intelligent information display. Instead of just listing the car type and license plate number, the display information may include a picture of the car, along with a picture of the suspect and the victim, and any other information that would assist in bringing the problem to a successful resolution. In yet another embodiment, the display information might be adjusted according to current weather conditions. For example, if the weather is taking a turn for the worse, the display information might include advertisements from nearby hotels with available vacancy.

In each of the exemplary methods described herein, various combinations and permutations of the described blocks or steps may be present and additional steps may be added. Further, one or more of the described blocks or steps may be absent from various embodiments. It is contemplated and within the scope of the present invention that the combinations and permutations of the described exemplary methods, as well as any additional or absent steps, may occur. The various methods are herein described for exemplary purposes only and are in no way intended to limit the scope of the present invention.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain the ends and objects set forth above, together with other advantages which are obvious and inherent to the methods, computer-readable media, and graphical user interfaces. It will be understood that certain features and sub-combinations are of utility and may be employed without reference to other features and sub-combinations. This is contemplated by and within the scope of the claims.

The invention claimed is:

1. A computer-implemented method for intelligent information display, comprising:
monitoring a display environment for one or more audience data;
upon receiving the one or more audience data, processing display information in accordance with the one or more audience data; and
presenting the processed display information.

2. The method of claim 1, wherein the one or more audience data includes one or more user gestures.

3. The method of claim 2, wherein processing the display information in accordance with the one or more audience data comprises:
applying a region of attention on the area of the one or more user gestures;
determining whether the one or more user gestures include a mouse motion in a computing device;
determining whether the one or more user gestures include a mouse click in a computing device; and
upon determining at least one of the mouse motion and the mouse click, adjusting the display information in accordance with the mouse motion or the mouse click.

4. The method of claim 3, wherein determining whether the one or more user gestures includes the mouse motion comprises:
measuring an optical flow in the region of attention; and
estimating a user gesture position in relation to display screen coordinates.

5. The method of claim 3, wherein determining whether the one or more user gestures includes the mouse click comprises:
measuring a dwell time in the region of attention;
measuring an activation in the region of attention; and
determining whether a combination of the dwell time and the activation indicates the mouse click.

6. The method of claim 3, wherein adjusting the display information in accordance with the mouse motion or the mouse click comprises preparing for a display interactive advertising targeted to a user based upon the one or more user gestures.

7. The method of claim 1, wherein the one or more audience data includes one or more audience measurement indicia.

8. The method of claim 7, wherein processing the display information in accordance with the one or more audience data comprises:
determining whether the one or more audience measurement indicia includes a demographic indicia; and
upon determining the demographic indicia, adjusting the display information in accordance with a face detection.

9. The method of claim 8, wherein determining whether the one or more audience measurement indicia includes the demographic indicia comprises:
using a collection of facial features to determine if the environment includes a face;
upon determining that the environment includes the face, performing a gender recognition and an age classification.

10. The method of claim 8, wherein adjusting the display information in accordance with the face detection comprises preparing for a display demographic-specific advertising classified by at least one of an age and a gender targeted to an audience based upon the one or more audience measurement indicia.

11. A computerized system for an intelligent information display, the system comprising:
a monitoring component configured to monitor a display environment and to receive data from an activity in the display environment;
a gesture recognition component configured to recognize user gestures in the display environment;
an audience measurement component configured to determine an audience demographic information of the display environment; and
a database for storing received information from the display environment.

12. The system of claim 11, further comprising a presentation component configured to present a display information based upon at least one of the user gestures and the audience demographic information received from activity in the display environment.

13. The system of claim 12, wherein the presentation component is further configured to present an intelligent, interactive advertisement information.

14. The system of claim 11, further comprising an impact measurement component configured to measure a typical size of the audience in the display environment and to determine an amount of time individual audience members remain in the display environment.

15. The system of claim 11, further comprising an advertiser exposure component configured to transmit the audience demographic information and an impact measurement information to advertisers and potential advertisers.

16. One or more computer readable media having instructions embodied thereon that, when executed, perform a method for an intelligent information display, the method comprising:
monitoring a display environment for one or more traffic data;
upon receiving the one or more traffic data, processing a display information in accordance with the one or more traffic data; and
presenting the processed display information.

17. The media of claim 16,
wherein the one or more traffic data includes at least one of a traffic speed information and a traffic congestion information, and
wherein processing the display information comprises adjusting, on an electronic billboard, an amount of time each advertisement is displayed according to at least one of the traffic speed information and the traffic congestion information, thereby customizing a display on the electronic billboard based upon current traffic conditions.

18. The media of claim 16,
wherein the one or more traffic data includes a vehicle-type information, and
wherein processing the display information comprises adjusting, on an electronic billboard, a type of advertisement displayed according to the vehicle type information, thereby customizing a display on the electronic billboard by targeting displayed advertisements based upon types of vehicles currently in the display environment.

19. The media of claim 16,
wherein the one or more traffic data includes a weather information, and
wherein processing the display information comprises adjusting, on an electronic billboard, a type of advertisement displayed according to the weather information, thereby customizing a display on the electronic billboard based upon prevailing weather conditions.

20. The media of claim 16,
wherein the one or more traffic data includes a public service information, and
wherein processing the display information comprises adjusting, on an electronic billboard, a type of information displayed according to the public service information, thereby customizing the electronic billboard to display public service announcements.
